(19) United States
(12) Patent Application Publication
(10) Pub. No.: US 2019/0122032 A1
(43) Pub. Date: Apr. 25, 2019

(54) METHOD AND SYSTEM FOR OPTIMIZING FACE RECOGNITION BASED ON MOBILE TERMINAL

(71) Applicant: JRD COMMUNICATION (SHENZHEN) LTD, Shenzhen (CN)

(72) Inventors: Yage You, Shenzhen (CN); Mingqiu Zhang, Shenzhen (CN)

(21) Appl. No.: 16/225,112

(22) Filed: Dec. 19, 2018

Related U.S. Application Data
(63) Continuation of application No. PCT/CN2017/091990, filed on Jul. 6, 2017.

(30) Foreign Application Priority Data
Jul. 6, 2016 (CN) 201610526499.9

(51) Int. Cl. G06K 9/00; G06T 7/00; G06F 9/54

(52) U.S. Cl. CPC G06K 9/00288; G06T 2207/10048; G06F 9/542; G06T 7/0002

(57) ABSTRACT

The present disclosure discloses a method and a system for optimizing face recognition based on a mobile terminal, and the method includes: when face recognition needs to be performed, determining the thermal phenomenon of an object and detecting whether infrared thermal is generated; prompting the failure of face recognition, when it is detected that the object recognized does not have the infrared thermal phenomenon; and performing the face recognition when it is detected that the object recognized has the infrared thermal phenomenon.

### CROSS-REFERENCE TO RELATED APPLICATIONS

The present application is a continuation-application conversion of International (PCT) Patent Application No. PCT/CN2017/091990 filed on Jul. 6, 2017, which claims foreign priority of Chinese Patent Application No. 201610526499.9, filed on Jul. 6, 2016 in the National Intellectual Property Administration of China, the contents of all of which are hereby incorporated by reference.

### TECHNICAL FIELD

The present disclosure relates to a technical field of mobile terminals, and more particularly, relates to a method and a system for optimizing face recognition based on a mobile terminal.

### BACKGROUND

The face recognition technology has become more and more mature, and has found wide applications in systems such as banks, customs or the like. However, the face recognition technology is less applied in mobile phones and tablet computers, and one important reason is that cameras currently available only support plane face recognition, and cannot perform 3D face recognition. This makes the face recognition easy to be cracked by using photos or videos, so the security cannot be guaranteed.

Accordingly, the prior art still needs to be improved and developed.

### SUMMARY

A technical problem to be solved by the present disclosure is to provide a method and a system for optimizing face recognition based on a mobile terminal with respect to the aforesaid drawback of the prior art. The present disclosure uses an infrared module to determine whether an object has a feature of a real person, i.e., the generation of infrared thermal, thereby improving the security of face recognition.

A technical solution adopted by the present disclosure to solve the aforesaid technical problem is as follows.

According to an aspect of the disclosure, a method for optimizing face recognition based on a mobile terminal may include the following actions: determining the thermal phenomenon of an object and detecting whether infrared thermal is generated when face recognition needs to be performed, and determining that a result of a feature of the object is a photo or a video and prompting the failure of face recognition when it is detected that the object recognized does not have the infrared thermal phenomenon, performing the face recognition by calling a face recognition algorithm when it is detected that the object recognized has the infrared thermal phenomenon.

In some embodiments, before the face recognition needs to be performed, the method further including: providing in advance an infrared module for detecting infrared thermal on the mobile terminal.

According to another aspect of the disclosure, a method for optimizing face recognition based on a mobile terminal including: determining the thermal phenomenon of an object and detecting whether infrared thermal is generated when face recognition needs to be performed; and prompting the failure of face recognition when it is detected that the object recognized does not have the infrared thermal phenomenon; performing the face recognition when it is detected that the object recognized has the infrared thermal phenomenon.

In some embodiments, before the face recognition needs to be performed, the method further including: providing in advance an infrared module for detecting infrared thermal on the mobile terminal.

In some embodiments, the prompting the failure of face recognition when it is detected that the object recognized does not have the infrared thermal phenomenon further includes: perform the face recognition by calling a face recognition algorithm when it is detected that the object recognized has the infrared thermal phenomenon.

In some embodiments, the prompting the failure of face recognition when it is detected that the object recognized does not have the infrared thermal phenomenon includes: determine that a result of the feature of the object is a photo or a video and prompting the failure of face recognition when it is detected that the object recognized does not have the infrared thermal phenomenon.

The method for optimizing face recognition based on a mobile terminal provided by the present disclosure adopt the infrared module to determine whether the object has the infrared thermal phenomenon, and use the conventional face recognition algorithm to perform face recognition when it is determined that the object generates thermal. When the object does not generate thermal, then it is determined that the object is a virtual object, i.e., a photo or a video. The whole operation of the infrared module can be accomplished within milliseconds, so the efficiency of the whole face recognition system will not be influenced. The present disclosure uses the infrared module to determine whether the object has the feature of a real person, i.e., the generation of infrared thermal, thereby improving the security of face recognition.

### BRIEF DESCRIPTION OF THE DRAWINGS

FIG. 1 is a flowchart diagram of one embodiment of a method for optimizing face recognition based on a mobile terminal according to the present disclosure.

FIG. 2 is a functional block diagram of one embodiment of a system for optimizing face recognition based on a mobile terminal according to the present disclosure.

### DETAILED DESCRIPTION

The present disclosure will be detailed hereinafter with reference to attached drawings and embodiments.

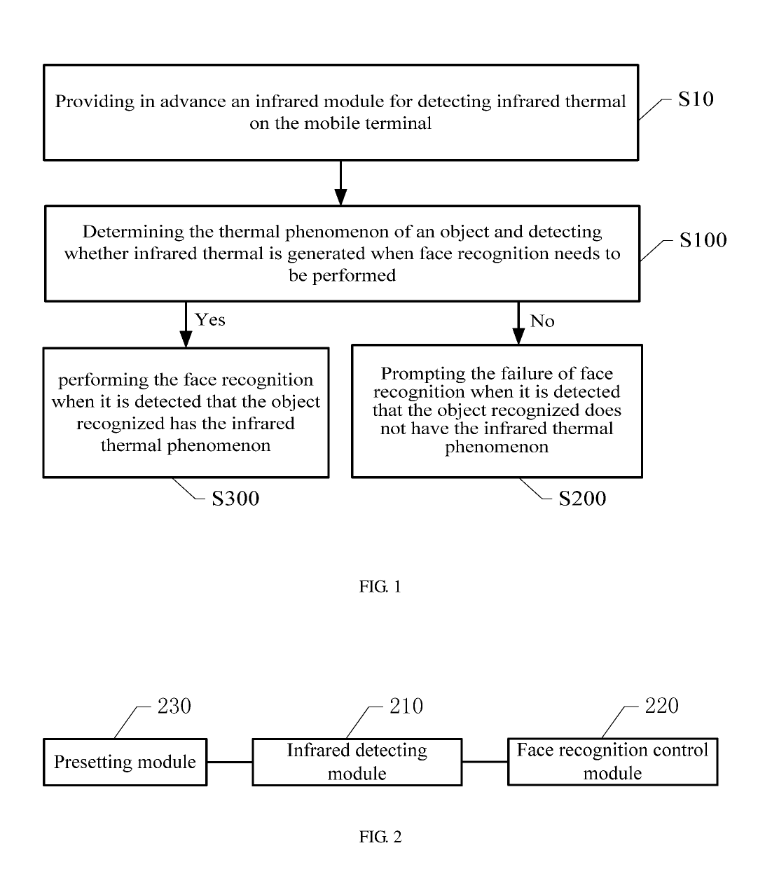

Referring to FIG. 1, FIG. 1 is a flowchart diagram of one embodiment of a method for optimizing face recognition based on a mobile terminal according to the present disclosure. A method for optimizing face recognition based on a mobile terminal may include the following blocks.

In block S10, an infrared module may be provided in advance for detecting infrared thermal on the mobile terminal.

Before the specific implementation of the present disclosure, an infrared module for detecting infrared thermal needs to be provided on a mobile phone. Of course, this block may be omitted when the mobile phone has already been provided with the infrared module when it leaves the factory.

In block S100, the thermal phenomenon of an object may be determined and be detected whether infrared thermal is generated when face recognition needs to be performed. When the determination result is no, entering into block S200; and when the determination result is yes, entering into block S300.

In this block, when face recognition needs to be performed, the thermal phenomenon of an object recognized is detected by using the infrared module disposed on the mobile phone so as to determine whether the object has a feature of a real human face. When it is detected that the object recognized does not have the infrared thermal phenomenon, i.e., the object does not have the feature of a real person, the method enters into the block S200. When it is detected that the object recognized has the infrared thermal phenomenon, i.e., the object has the feature of a real person, the method enters into the block S300.

In block S200, the failure of face recognition may be prompted when it is detected that the object recognized does not have the infrared thermal phenomenon.

When it is detected that the object recognized does not have the infrared thermal phenomenon, i.e., the object does not have the feature of the real human face, then it is determined that a result of the feature of the object is a photo or a video and failure of face recognition is prompted.

In block S300, the face recognition may be performed when it is detected that the object recognized has the infrared thermal phenomenon.

In this block, when it is detected that the object recognized has the infrared thermal phenomenon, i.e., the object has the feature of the real human face, then the algorithm of the method is called to perform face recognition.

As can be known from the above descriptions, the embodiments of the method of the present disclosure adopt the infrared module to determine whether the object has the infrared thermal phenomenon, and use the conventional face recognition algorithm to perform face recognition when it is determined that the object generates thermal. When the object does not generate thermal, then it is determined that the object is a virtual object, i.e., a photo or a video. The whole operation of the infrared module can be accomplished within milliseconds, so the efficiency of the whole face recognition system will not be influenced.

Based on the embodiments of the aforesaid method, the present disclosure further provides a system for optimizing face recognition based on a mobile terminal, as shown in FIG. 2, the system may include: an infrared detecting module 210, a face recognition control module 220 and a presetting module 230.

The infrared detecting module 210 is configured to, when face recognition needs to be performed, determine the thermal phenomenon of an object and detect whether infrared thermal is generated, specifically as described above.

The face recognition control module 220 is configured to prompt the failure of face recognition when it is detected that the object recognized does not have the infrared thermal phenomenon, i.e., the object does not have the feature of the real human face; and perform the face recognition when it is detected that the object recognized has the infrared thermal phenomenon, i.e., the object has the feature of the real human face, specifically as described above.

The presetting module 230 is configured to provide in advance an infrared module for detecting infrared thermal on the mobile terminal, specifically as described above.

Further speaking, in the system for optimizing face recognition based on a mobile terminal. The face recognition control module may include: a face recognition unit, the face recognition unit is configured to call a face recognition algorithm to perform the face recognition when it is detected that the object recognized has the infrared thermal phenomenon, i.e., the object has the feature of the real human face, specifically as described above.

Further speaking, in the system for optimizing face recognition based on a mobile terminal, the face recognition control module may include: a face recognition failure prompting unit. The face recognition failure prompting unit is configured to determine that the result of the feature of the object is a photo or a video and prompt the failure of face recognition when it is detected that the object recognized does not have the infrared thermal phenomenon, i.e., the object does not have the feature of the real human face, specifically as described above.

According to the above descriptions, the method and system for optimizing face recognition based on a mobile terminal provided by the present disclosure adopt the infrared module to determine whether the object has the infrared thermal phenomenon, and use the conventional face recognition algorithm to perform face recognition when it is determined that the object generates thermal. When the object does not generate thermal, then it is determined that the object is a virtual object, i.e., a photo or a video. The whole operation of the infrared module can be accomplished within milliseconds, so the efficiency of the whole face recognition system will not be influenced. The present disclosure uses the infrared module to determine that the object has the feature of the real person, i.e., the generation of infrared thermal, thereby improving the security of face recognition.

Of course, as shall be appreciated by those of ordinary skill in the art, the implementation of all or a part of the processes in the aforesaid embodiment of the method may be accomplished by instructing a relevant hardware (e.g., a processor, a controller or the like) via a computer program, the program may be stored in a computer-readable storage medium, and the program, when being executed, may comprise the processes of the aforesaid embodiment of the method. The storage medium may be a storage, a magnetic disk, a compact disk or the like.

What described above are only the embodiments of the present disclosure, but are not intended to limit the scope of the present disclosure. Any equivalent structures or equivalent process flow modifications that are made according to the specification and the attached drawings of the present disclosure, or any direct or indirect applications of the present disclosure in other related technical fields shall all be covered within the scope of the present disclosure.

What is claimed is:

1. A method for optimizing face recognition based on a mobile terminal, comprising:
determining the thermal phenomenon of an object and detecting whether infrared thermal is generated when face recognition needs to be performed; and
determining that a result of a feature of the object is a photo or a video and prompting the failure of face recognition when it is detected that the object recognized does not have the infrared thermal phenomenon; or
performing the face recognition by calling a face recognition algorithm when it is detected that the object recognized has the infrared thermal phenomenon.

2. The method for optimizing face recognition based on a mobile terminal according to claim 1, before the face recognition needs to be performed, further comprising:
providing in advance an infrared module for detecting infrared thermal on the mobile terminal.

3. A method for optimizing face recognition based on a mobile terminal, comprising:
determining the thermal phenomenon of an object and detecting whether infrared thermal is generated when face recognition needs to be performed; and
prompting the failure of face recognition when it is detected that the object recognized does not have the infrared thermal phenomenon;
performing the face recognition when it is detected that the object recognized has the infrared thermal phenomenon.

4. The method for optimizing face recognition based on a mobile terminal according to claim 3, before the face recognition needs to be performed, further comprising:
providing in advance an infrared module for detecting infrared thermal on the mobile terminal.

5. The method for optimizing face recognition based on a mobile terminal according to claim 3, wherein the prompting the failure of face recognition when it is detected that the object recognized does not have the infrared thermal phenomenon further comprises:
perform the face recognition by calling a face recognition algorithm when it is detected that the object recognized has the infrared thermal phenomenon.

6. The method for optimizing face recognition based on a mobile terminal according to claim 3, wherein the prompting the failure of face recognition when it is detected that the object recognized does not have the infrared thermal phenomenon comprises:
determine that a result of the feature of the object is a photo or a video and prompting the failure of face recognition when it is detected that the object recognized does not have the infrared thermal phenomenon.

7. A system for optimizing face recognition based on a mobile terminal, comprising:
a detector configured to detect whether infrared thermal is generated by an object when face recognition needs to be performed;
a storage configured to store computer instructions; and
a processor, executing the computer instructions, configured to:
determine whether the object has the thermal phenomenon; and
perform the face recognition when it is detected that the object recognized has the infrared thermal phenomenon; or
prompt the failure of face recognition when it is detected that the object recognized does not have the infrared thermal phenomenon.

8. The system for optimizing face recognition based on a mobile terminal according to claim 7, wherein the processor is further configured to:
call a face recognition algorithm to perform the face recognition when it is detected that the object recognized has the infrared thermal phenomenon.

9. The system for optimizing face recognition based on a mobile terminal according to claim 7, wherein the processor is further configured to:
determine that the result of the feature of the object is a photo or a video and prompt the failure of face recognition when it is detected that the object recognized does not have the infrared thermal phenomenon.
